(19) United States
(12) Patent Application Publication
(10) Pub. No.: US 2025/0323373 A1
(43) Pub. Date: Oct. 16, 2025

(54) BATTERY SYSTEM WITH IMPROVED END PLATE

(71) Applicant: SAMSUNG SDI CO., LTD., Yongin-si (KR)

(72) Inventor: Martin BLODER, Sinabelkirchen (AT)

(21) Appl. No.: 18/807,736

(22) Filed: Aug. 16, 2024

(30) Foreign Application Priority Data
Apr. 10, 2024 (EP) 24169462.9

(51) Int. Cl. H01M 50/264; B60L 50/64; H01M 50/204; H01M 50/224; H01M 50/249

(52) U.S. Cl. CPC H01M 50/264; B60L 50/64; H01M 50/204; H01M 50/224; H01M 50/249; H01M 2220/20

(57) ABSTRACT

A battery system including: a cell stack including a plurality of battery cells arranged along a stacking axis; and a cell stack frame accommodating the cell stack. The cell stack frame includes frame walls and an end plate, and the frame walls include second interlocking elements. The end plate includes: first interlocking elements at opposite lateral sides of the end plate, the first interlocking elements being configured to interlock with the second interlocking elements of the frame walls in a fixture position of the end plate and for establishing a snap fit connection between the end plate and the frame walls such that the end plate exerts pressure onto the cell stack; a plate element facing the cell stack that, in the fixture position, exerts pressure onto the cell stack; and lateral wall elements extending from the plate element in a direction away from the cell stack.

### CROSS REFERENCE TO RELATED APPLICATION

The present application claims priority to and the benefit of European Patent Application Ser. No. 24/169,462.9, filed on Apr. 10, 2024, in the European Patent Office, the entire disclosure of which is incorporated herein by reference.

### BACKGROUND

### 1. Field

Aspects of embodiments of the present disclosure relate to a battery system with an improved end plate.

### 2. Description of the Related Art

Recently, vehicles for transportation of goods and peoples have been developed that use electric power as a source for motion. Such an electric vehicle is an automobile that is propelled, permanently or temporarily, by an electric motor using energy stored in rechargeable batteries. An electric vehicle may be solely powered by batteries (a so-called Battery Electric Vehicle or BEV) or may include a combination of an electric motor and, for example, a conventional combustion engine (a so-called Plugin Hybrid Electric Vehicle or PHEV). BEVs and PHEVs use high-capacity rechargeable batteries that are designed to provide power for propulsion over sustained periods of time.

Generally, a rechargeable (or secondary) battery cell includes an electrode assembly including a positive electrode, a negative electrode, and a separator interposed between the electrodes. A solid or liquid electrolyte allows for movement of ions during charging and discharging of the battery cell. The electrode assembly is located (or arranged) in a casing and electrode terminals, which are positioned on the outside of the casing, establish an electrically conductive connection to the electrodes. The casing may have, for example, a cylindrical or rectangular shape.

A battery module is generally formed of a plurality of battery cells connected together in series or in parallel. For example, the battery module is formed by interconnecting the electrode terminals of the plurality of battery cells in a number and configuration depending on a desired amount of power and to provide a high-power rechargeable battery.

Battery modules can be constructed in either a block design or in a modular design. In the block design, each battery cell is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage.

A battery pack is a set of any number of (usually identical) battery modules or single battery cells. The battery modules, or the respective battery cells, may be configured in a series, parallel, or a mixture of both to provide the desired voltage, capacity, and/or power density. Components of a battery pack include the individual battery modules and interconnects, which provide electrical conductivity between the battery modules.

The battery cells of a battery pack may be arranged to form a cell stack by stacking the battery cells onto each other or by arranging the battery cells in a row. Neighboring battery cells in a cell stack may be distanced (or spaced apart) from one another via cell spacers. The cell stack may be placed inside a cell stack frame delimiting the battery cells to the outside. Pressure (e.g., predefined pressure) is exerted onto the battery cells by the cell stack frame to compensate for possible production tolerances and swelling of the battery cells to ensure optimal operation of the battery cells over their lifetime.

Conventional assembly methods for battery cells provide that the cell stack is pre-compressed via an insertion clamp and inserted into a cavity of the cell stack frame where the cell stack is then held in the compressed state via the end plates. To enable a damage free and force free placement of the cell stack into the cavity, the cell stack must be over-compressed, putting the battery cells under great pressure. Most of this pre-tension of the cell stack is lost when the insertion clamp is released and the cells are allowed to expand to completely fill the cavity. The pre-compression outside of the cell stack frame and the insertion of the stressed cell stack into the cavity may be cumbersome and complicated. Further, the level of achievable compression of the cell stack in its final assembly, that is, after expanding, is relatively low.

As an alternative assembly method, the cell stack may be inserted into the cell stack frame without pre-compression and may then be compressed by pressing one of the end plates against the cell stack and fixing the end plate in its position while the stack is held under pressure. In this case, the fixing of the end plate is usually performed by welding, bolting, or screwing the end plate to side walls of the cell stack frame, which may be time consuming and prone to error because it may be difficult to place the end plate correctly to ensure that the right amount of pressure is exerted onto the cell stack.

### SUMMARY

The present disclosure is defined by the appended claims and their equivalents. The description that follows is subject to this limitation. Any disclosure lying outside the scope of the claims and their equivalents is intended for illustrative as well as comparative purposes.

According to embodiments of the present disclosure, a battery system with an improved cell stack frame that can be more simply assembled while ensuring that a desired compression of the cell stack is achieved is provided.

According to an embodiment of the present disclosure, A battery system includes: a cell stack including a plurality of battery cells arranged along a stacking axis; and a cell stack frame accommodating the cell stack. The cell stack frame includes frame walls and an end plate, and the frame walls include second interlocking elements. The end plate includes: first interlocking elements at opposite lateral sides of the end plate, the first interlocking elements being configured to interlock with the second interlocking elements of the frame walls in a fixture position of the end plate and for establishing a snap fit connection between the end plate and the frame walls such that the end plate exerts pressure onto the cell stack; a plate element facing the cell stack that, in the fixture position, exerts pressure onto the cell stack; and lateral wall elements extending from the plate element in a direction away from the cell stack.

According to another embodiment of the present disclosure, the first interlocking elements may be cantilever snap-fit elements, and the second interlocking elements may be receptacles configured to receive the cantilever snap-fit elements. In another embodiment of the present disclosure, the second interlocking elements may be cantilever snap-fit elements, and the first interlocking elements may be receptacles configured to receive the cantilever snap-fit elements.

According to another embodiment of the present disclosure, the first interlocking elements may be arranged at opposite ones of the lateral wall elements.

According to another embodiment of the present disclosure, the lateral wall elements may abut inner sides of the frame walls of the cell stack frame.

According to another embodiment of the present disclosure, the end plate may include first interlocking elements at all four lateral sides, and the frame walls of the cell stack frame may include two side walls, a top cover, and a bottom cover. Each of the side walls, the top cover, and the bottom cover may have the second interlocking elements such that, in the fixture position of the end plate, a snap fit connection is established between the end plate and the two side walls, the top cover, and the bottom cover.

According to another embodiment of the present disclosure, the end plate and the first interlocking elements may be integrally formed (e.g., are formed as one piece), such as from a sheet metal.

According to another embodiment of the present disclosure, the end plate may include metal.

According to another embodiment of the present disclosure, the end plate may be made of pressed steel.

Another embodiment of the present disclosure refers to an electric vehicle including the battery system as described above.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic top view of a battery system according to an embodiment.

FIG. 2 is a perspective view of an end plate of the battery system shown in FIG. 1.

FIG. 3A is a front view of the end plate shown in FIG. 2.

FIG. 3B is a side view of the end plate shown in FIG. 2.

FIG. 3C is a top view of the end plate shown in FIG. 2.

FIG. 4A is a cross-sectional view of the battery system shown in FIG. 1 before compressing.

FIG. 4B is a cross-sectional view of the battery system shown in FIG. 1 during compressing.

FIG. 4C is a cross-sectional view of the battery system shown in FIG. 1 after compressing.

### DETAILED DESCRIPTION

Reference will now be made, in detail, to embodiments, examples of which are illustrated in the accompanying drawings. Aspects and features of the embodiments, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be only briefly described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

As used herein, the term “substantially,” “about,” and similar terms are used as terms of approximation and not as terms of degree and are intended to account for inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to an embodiment of the present disclosure, a battery system includes a plurality of battery cells, for example, prismatic or pouch type battery cells. The battery cells are arranged to form a cell stack, for example, by being stacked onto each other or by being arranged in a row along a stacking axis. Cell spacers may be disposed in-between adjacent or neighboring battery cells. Thus, neighboring battery cells of the cell stack may be distanced (or spaced apart) from one another via a cell spacer. The cell stack may form one or more battery packs.

The cell stack is disposed inside a cell stack frame. The cell stack frame includes at least two opposite frame walls, for example, two frame walls that are disposed opposite each other. The frame walls delimit an interior space or cavity of the cell stack frame, and the interior space or cavity houses (or accommodates) the cell stack. The cell stack frame may include four frame walls, for example, two opposite side walls, a top cover, and a bottom cover disposed opposite the top cover. The cell stack frame may, thus, have a quadrilateral shape or cross-section, such as a rectangular shape or cross-section. Further, the cell stack frame includes at least one end plate. The cell stack frame may include two end plates. The cell stack arranged inside the cell stack frame may, thus, be delimited on at least four sides by the end plates and frame walls or on all six sides if four frame walls are provided. The cell stack frame may delimit the cell stack to an outside, that is, to an external environment of the cell stack. The end plate may form an outer delimitation of the cell stack frame. Also, the other end plate and/or the frame walls may form the outer delimitation(s) of the cell stack frame. For example, the cell stack frame, which includes the two end plates and the frame walls, may delimit an interior space or cavity of the cell stack frame from the exterior with the cell stack arranged in the interior space or cavity. One or both of the end plates may exert pressure onto the cell stack.

The end plate includes first interlocking elements that are disposed at opposite lateral sides of the end plate. The first interlocking elements are disposed at the lateral sides of the end plate that face the frame walls. The frame walls include corresponding second interlocking elements. For example, the frame walls may be two opposite side walls of the cell stack frame, and the first interlocking elements may be arranged at a first lateral side of the end plate facing a first one of the side walls and at a second lateral side opposite the first lateral side. The second lateral side may face the second one of the side walls. The first interlocking elements and the second interlocking elements are, in one embodiment, snap-fit elements configured to establish a snap-fit connection. For example, the interlocking elements form protruding edges and corresponding snap-in areas. Thus, the first and second interlocking elements are configured to interlock with each other in a fixture (or fixed) position of the end plate such that a snap fit connection is established between the end plate and the frame walls. In this fixture position, the end plate is placed (or arranged) such that the end plate exerts pressure onto the cell stack. For example, the end plate presses against the cell stack. If the cell stack frame includes two end plates, both end plates may include such first interlocking elements and may, thus, be fixed to the frame walls via such a snap-fit connection. The first and second interlocking elements may be integral elements/parts of the end plate and frame walls, respectively. The interlocking elements may be configured to establish a permanent or removable (e.g., multiple use) snap fit connection.

When assembling the battery system, according to an embodiment of the present disclosure, the cell stack may be placed (or arranged) inside the interior space or cavity delimited by the frame walls of the cell stack frame without any pre-compression. After inserting the cell stack, the end plate may be inserted into the interior space or cavity and pressed against the cell stack, thereby compressing the cell stack, for example, thereby reducing a cell stack length, until the end plate reaches the predefined fixture position and the first and second interlocking elements interlock to thereby establish the snap-fit connection. The fixture position, for example, the position of the second interlocking elements, may be chosen (or configured or located) such that a desired compression of the cell stack is achieved. The end plate, thus, automatically locks into place when the desired compression of the cell stack is accomplished. This simplifies assembly and ensures that a desired compression of the cell stack is achieved. The end plate does not need to be held in place because it is not fixed to the frame walls via riveting or welding but automatically via its integral locking elements.

According to an embodiment, the first interlocking elements are cantilever snap-fit elements, and the second interlocking elements are receptacles for the cantilever snap-fit elements. Alternatively, the second interlocking elements are cantilever snap-fit elements, and the first interlocking elements are receptacles for the cantilever snap-fit elements. The first interlocking elements may, thus, as cantilever snap-fit elements, be integrally formed with the end plate as structural elements, for example, (canti)levers supported at one end and extending from the lateral sides of the end plate at an angle towards the outside. The second interlocking elements may, thus, be formed as receptacles configured to receive the cantilever snap-fit elements. In other embodiments, the second interlocking elements may be formed as a cantilever snap-fit elements, and the first interlocking elements of the end plate may be formed as receptacles configured to receive the cantilever snap-fit elements. The snap-fit may be removable (or undoable), for example, the cantilever snap-fit elements may be removed (or may be removable) from their respective receptacle. For example, when the cantilever snap-fit elements include a (canti)lever, the (canti)lever may be pushed inwardly such that the snap-fit is released or undone. A cantilever snap-fit may be simple to manufacture and may ensure simplified assembly of the battery system and that a desired compression of the cell stack is achieved.

The end plate includes a plate element facing the cell stack and, in the fixture position, exerts pressure onto the cell stack. Lateral wall elements of the plate element extend from the plate element in a direction away from the cell stack (e.g., along the stacking axis). In an embodiment, the first interlocking elements are arranged at opposite ones of the lateral wall elements. The plate element may be a part of the end plate that abuts the cell stack and presses against the cell stack. The end plate may be rectangular, having four lateral wall elements forming four lateral sides of the plate element. Two opposite ones of these four lateral wall elements that face the side walls of the cell stack frame may include the first interlocking elements. The lateral wall elements may facilitate the placing of the end plate into the fixture position and may help guide the end plate into the fixture position. The lateral wall elements may, thus, further simplify the assembly of the battery system and may ensure that a desired compression of the cell stack is achieved.

According to an embodiment, the lateral wall elements abut the inner sides of the frame walls of the cell stack frame. For example, the lateral wall elements contact the inner sides of the frame walls. The lateral wall elements may face and extend parallel to the frame walls. For example, the lateral wall elements may abut inner sides of the side walls, an inner side of a top cover, and/or an inner side of a bottom cover of the cell stack frame. When the end plate is rectangular having four lateral wall elements forming four lateral sides of the plate element, each of the four lateral wall elements may abut the inner side of the frame wall it is facing. The end plate may, thus, securely close an end of the cell stack frame, for example, of the interior space or cavity. The lateral wall elements abutting the inner sides of the frame walls of the cell stack frame may facilitate the placing of the end plate into the fixture position, for example, they may help guide the end plate into the fixture position. The lateral wall elements may, thus, further simplify the assembly of the battery system and may ensure that a desired compression of the cell stack is achieved.

According to an embodiment, the end plate includes first interlocking elements at all four lateral sides, and the frame walls of the cell stack frame include two side walls, a top cover, and a bottom cover. Each of the side walls, the top cover, and the bottom cover have second interlocking elements, and, in the fixture position of the end plate, a snap fit connection is established between the end plate and the two side walls, the top cover, and the bottom cover. In this embodiment, the end plate may include the first interlocking elements not only at two opposite lateral sides but at all four lateral sides. Correspondingly, each of the four frame walls of the cell stack frame may have the second interlocking elements. For example, as described, the end plate may be rectangular having four lateral wall elements forming four lateral sides of the plate element, and the cell stack frame may include four frame walls, each facing one of the lateral wall elements. Each of the lateral wall elements may include first interlocking elements configured to interlock with second interlocking elements of the opposite frame walls. Thus, in the fixture position, a snap-fit connection may be achieved between all four lateral sides/lateral wall elements and the respective frame wall (e.g., the two side walls, the top cover, and the bottom cover) the lateral sides/lateral wall elements are facing. This may result in a particularly secure snap-fit connection and may ensure that the end plate automatically locks into place when the end plate reaches the fixture position and, thus, the moment the desired compression of the cell stack is accomplished, which simplifies assembly and ensures that a desired compression of the cell stack is achieved.

According to an embodiment, the end plate including the first interlocking elements is formed as one piece (e.g., is integrally formed). The entire end plate may be formed as one piece. For example, the end plate including the plate element, the lateral wall elements, and the first interlocking elements may be formed as one piece. The end plate may be formed as one piece from a sheet material. For example, the end plate may be formed from sheet metal, such as steel (e.g., pressed steel). Thus, the first interlocking elements, the plate element, and the lateral wall elements may form integral parts of the end plate. The end plate may, thus, be formed by processing a single sheet metal, for example, by deep-drawing, bending, folding, and/or cutting the sheet metal. The end plate may be formed without any connector, such as rivets or screws, and without welding. The displaceable end plate being formed as one-piece, for example, from a sheet material, may provide for a simple manufacturing while providing stability and flexibility to the end plate and may ensure that the end plate establishes and maintains the snap-fit connection with the frame walls. This simplifies assembly and ensures that a desired compression of the cell stack is achieved.

According to an embodiment, the battery system includes two end plates as described herein, with one end plate arranged at each end of (e.g., at opposite ends of) the cell stack frame. For example, each end plate may include, at opposite lateral sides thereof, first interlocking elements which are configured to interlock with second interlocking elements of the frame walls in a fixture position of the end plate for establishing a snap fit connection between the end plate and the frame walls such that the end plate exerts pressure onto the cell stack. Providing two such end plates may ensure the desired compression of the cell stack.

Embodiments of the present disclosure also pertain to an electric vehicle including a battery system as described herein.

According to an embodiment of the present disclosure, a method for assembling a battery system as described herein may be provided. Therein, the cell stack frame may be provided without the end plate placed in its fixture position. The cell stack may then be inserted into the interior space of the cell stack frame without pre-compression. Subsequently, the end plate may be moved into its fixture position at where the first and second interlocking elements interlock and establish the snap-fit connection, thereby compressing the cell stack to a desired (e.g., predefined) amount.

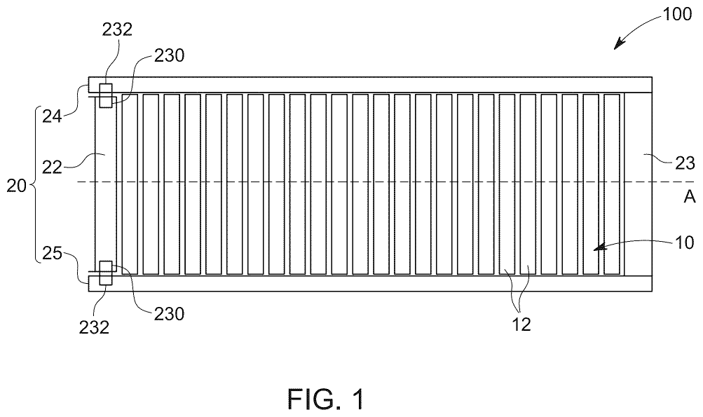

FIG. 1 is a schematic top view of a battery system 100 according to an embodiment. The battery system 100 includes a plurality of battery cells 12 arranged to form a cell stack 10 and a cell stack frame 20 accommodating the cell stack 10. The battery cells 12 are stacked or arranged along a stacking axis A.

The cell stack frame 20 includes two end plates 22, 23 and two side walls (e.g., frame walls) 24, 25 connecting the end plates 22, 23. The end plates 22, 23 and side walls 24, 25 delimit the cell stack 10 from four sides as shown in, for example, FIG. 1. The cell stack frame 20 may further include a top cover and a bottom cover to completely encase the cell stack 10. The two side walls 24, 25, the top cover, and the bottom cover may form frame walls of the cell stack frame 20.

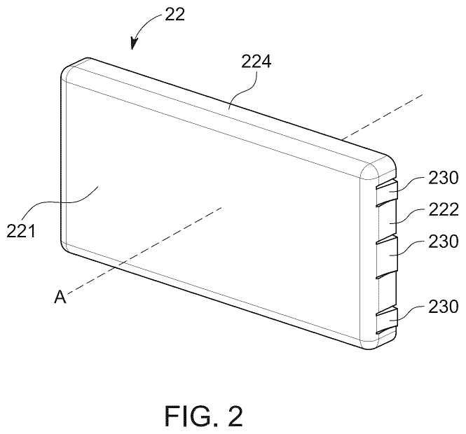

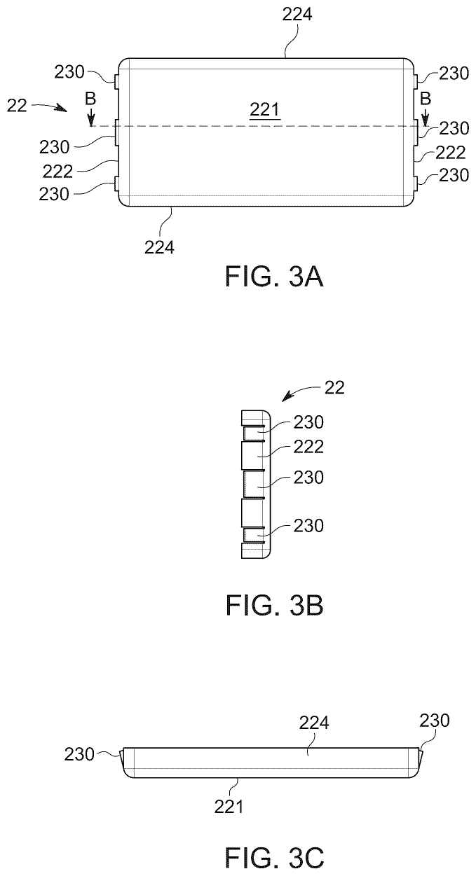

FIG. 2 is a perspective view of the end plate 22 of the battery system 100 according to an embodiment. FIGS. 3A, 3B, and 3C respectively illustrate a front view, a side view, and a top view of the end plate 22 shown in FIG. 2. Referring to FIG. 2 and FIGS. 3A-3C, the end plate 22 may have a rectangular shape and may include a rectangular plate element 221 facing the cell stack 10 and four lateral wall elements 222, 224 extending backwardly from the plate element 221 (e.g., extending in a direction away from the cell stack 10). The four lateral wall elements 222, 224 extend parallel to the frame walls, for example, toward (or to) the side walls 24, 25 and toward (or to) the top cover and the bottom cover (if present).

First interlocking elements 230 are provided at opposite lateral sides of the end plate 22, namely, at the lateral wall elements 222. Corresponding second interlocking elements 232 are provided at the side walls 24, 25 of the cell stack frame 20. The first interlocking elements 230 are cantilever snap-fit elements, and the second interlocking elements 232 are receptacles for (e.g., configured to receive) the cantilever snap-fit elements.

The end plate 22 is formed as one-piece from (e.g., is integrally formed from) a single sheet of metal, for example, from pressed steel. The end plate 22 may be formed from the sheet metal via, for example, deep-drawing the plate element 221 and the lateral wall elements 222, 224 and by cutting and bending the first interlocking elements 230.

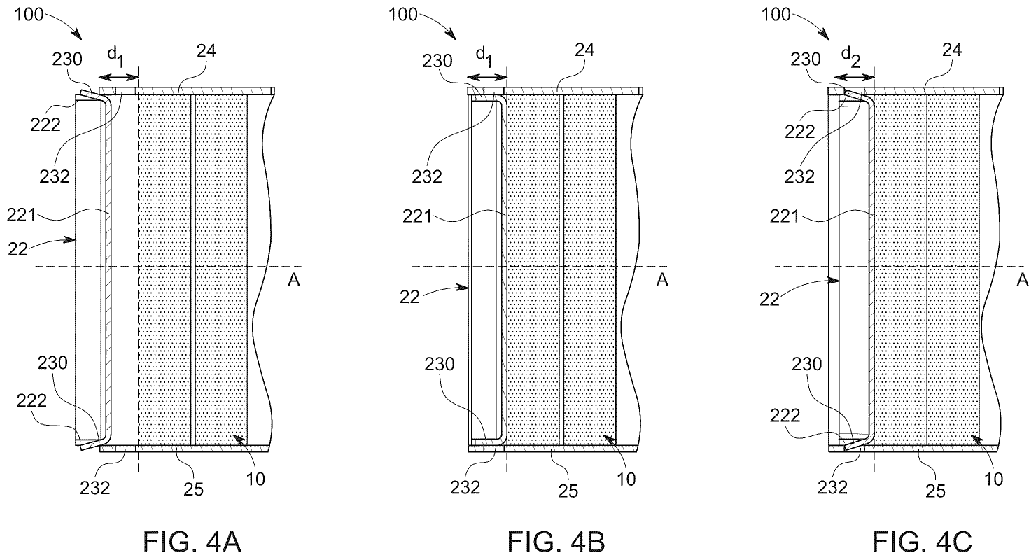

FIGS. 4A-4C illustrate partial cross-sectional views of the battery system 100 shown in FIG. 1 showing an insertion process of the end plate 22 into an interior space of the cell stack frame 20. Referring to FIG. 4A, when assembling the battery system 100, the cell stack 10 may be placed inside an interior space or cavity delimited by the side walls 24, 25 of the cell stack frame 20 without any pre-compression. After inserting the cell stack 10, the end plate 22 may be inserted into the interior space or cavity as shown in FIG. 4B. FIGS. 4A-4C show partial cross-sectional views of the battery system 100 shown in FIG. 1 taken along the line B-B in FIG. 3A.

In FIG. 4A, the end plate 22 is not yet inserted into the interior space or cavity of the cell stack frame 20. Thus, the first interlocking elements 230 are in their original, non-deformed state. As shown in FIG. 4A, an end side of the cell stack 10 is arranged at a first distance d₁ from an opening of the cell stack frame 20 through which the end plate 22 is introduced.

In FIG. 4B, the end plate 22 is moved into the interior space or cavity of the cell stack frame 20 such that the first interlocking elements 230 are deformed, for example, the cantilever snap-fit elements are deformed/pressed backwardly (or toward the center of the end plate 22). In this state, the plate element 221 of the end plate 22 already contacts the cell stack 10. Thus, the end plate 22 is moved so far towards the cell stack 10 that the side of the plate element 221 facing the end side of the cell stack 10 arranged at the first distance d₁ from the opening of the cell stack 10.

When moved further into the interior space or cavity of the cell stack frame 20, the end plate 22 reaches its fixture position as shown in FIG. 4C (and as schematically shown in FIG. 1). During this further movement, the end plate 22 is pressed against the cell stack 10, thereby compressing the cell stack 10. In the fixture position, the first interlocking elements 230 interlock with the second interlocking elements 232, for example, the cantilever snap-fit elements snap back into their original shape and into the receptacles, thereby establishing a snap fit connection between the end plate 22 and the side walls 24, 25. Thus, in the fixture position, the end plate 22 exerts a desired (e.g., predetermined) pressure onto the cell stack 10. As shown in FIG. 4C, the end plate 22 is moved so far towards the cell stack 10 that the side of the plate element 221 facing the end side of the cell stack 10 and the end side of the cell stack 10 is arranged at a second distance d₂ from the opening of the cell stack 10 such that the second distance d₂ is larger than the first distance d₁ (i.e., d₂>d₁). In this state, the lateral wall elements 222 abut the inner sides of the side walls 24, 25.

The end plate 22 thus automatically locks into place the moment the desired compression of the cell stack 10 is accomplished. This simplifies assembly and ensures that a desired compression of the cell stack 10 is achieved. The end plate 22 does not need to be held in place because it is not fixed to the side walls 24, 25 via riveting or welding but automatically via its integral first interlocking elements 230.

While inserting the end plate 22, the lateral wall elements 222 abut the side walls 24, 25 (and, if present, the lateral wall elements 224 contact the top cover and the bottom cover), thereby facilitating the placing of the end plate. The top cover and bottom cover, if provided, may also include second interlocking elements and the end plate 22 may, thus, further include first interlocking elements at the lateral wall elements 224 so that further snap-fit connections are established between the end plate 22 and the top cover and the bottom cover. This further simplifies assembly and ensures that a desired compression of the cell stack 10 is achieved.

Some Reference Symbols

| | | | |
|---|---|---|---|
| 10 | cell stack | 12 | battery cells |
| 20 | cell stack frame | 22 | end plate |
| 23 | end plate | 24 | side wall (frame wall) |
| 25 | side wall (frame wall) | 100 | battery system |
| 221 | plate element | 222 | lateral wall elements |
| 224 | lateral wall elements | 230 | first interlocking elements |
| 232 | second interlocking elements | A | stacking axis |

What is claimed is:

1. A battery system comprising:
a cell stack comprising a plurality of battery cells arranged along a stacking axis; and
a cell stack frame accommodating the cell stack, the cell stack frame comprising frame walls and an end plate, the frame walls comprising second interlocking elements,
wherein the end plate comprises:
first interlocking elements at opposite lateral sides of the end plate, the first interlocking elements being configured to interlock with the second interlocking elements of the frame walls in a fixture position of the end plate and for establishing a snap fit connection between the end plate and the frame walls such that the end plate exerts pressure onto the cell stack;
a plate element facing the cell stack that, in the fixture position, exerts pressure onto the cell stack; and
lateral wall elements extending from the plate element in a direction away from the cell stack.

2. The battery system as claimed in claim 1, wherein the first interlocking elements are cantilever snap-fit elements, and
wherein the second interlocking elements are receptacles configured to receive the cantilever snap-fit elements.

3. The battery system as claimed in claim 1, wherein the second interlocking elements are cantilever snap-fit elements, and
wherein the first interlocking elements are receptacles configured to receive the cantilever snap-fit elements.

4. The battery system as claimed in claim 1, wherein the first interlocking elements are respectively arranged at opposite ones of the lateral wall elements.

5. The battery system as claimed in claim 4, wherein the lateral wall elements abut inner sides of the frame walls of the cell stack frame.

6. The battery system as claimed in claim 1, wherein the first interlocking elements are respectively at all four lateral sides of the end plate,
wherein the frame walls of the cell stack frame comprise two side walls, a top cover, and a bottom cover, each of the side walls, the top cover, and the bottom cover having one of the second interlocking elements, and
wherein, in the fixture position of the end plate, a snap fit connection is established between the end plate and the two side walls, the top cover, and the bottom cover.

7. The battery system as claimed in claim 1, wherein the end plate and the first interlocking elements are integrally formed.

8. The battery system as claimed in claim 1, wherein the end plate comprises metal.

9. The battery system as claimed in claim 8, wherein the end plate is made of pressed steel.

10. The battery system as claimed in claim 1, further comprising two of the end plates, one at each end of the cell stack frame,
wherein each of the end plates comprises the first interlocking elements at opposite lateral sides thereof, the first interlocking elements being configured to interlock with the second interlocking elements of the frame walls in the fixture position of the end plates for establishing a respective snap fit connection between the end plates and the frame walls such that the end plates exert pressure onto the cell stack.

11. An electric vehicle comprising the battery system as claimed in claim 1.
